(19) United States
(12) Patent Application Publication
(10) Pub. No.: US 2005/0046114 A1
(43) Pub. Date: Mar. 3, 2005

(54) Rotary seal member, assembly and methods for a hydraulic rotary swivel

(76) Inventor: Stephan Ernst Bohner, Woodstock (CA)

Correspondence Address: CALFEE HALTER & GRISWOLD, LLP, 800 SUPERIOR AVENUE, SUITE 1400, CLEVELAND, OH, 44114, US

(21) Appl. No.: 10/649,484

(22) Filed: Aug. 27, 2003

(51) Int. Cl. F16J 15/34

(52) U.S. Cl. 277/358

(57) ABSTRACT

A rotary seal member, assembly and associated methods for use in a hydraulic rotary swivel are disclosed. The hydraulic rotary swivel includes a first part and a second part rotatable relative to each other. The rotary seal member is positioned between the first part and the second part and can be adapted to be securely retained in a corresponding retaining groove which may be formed in either one of the first part and the second part. In a preferred embodiment, the rotary seal member had an elongate body forming a ring, and has at least one protuberance formed along its length which fits into a cooperating depression formed along the retaining groove. In use, the protuberance and corresponding depression are coupled and cooperate to substantially prevent the rotary seal member from rotating within the retaining groove.

### FIELD OF THE INVENTION

The present invention relates to seal members, assemblies and methods, and in particular rotary seal members, assemblies and methods for a hydraulic rotary swivel.

### BACKGROUND

Rotary swivels are often used in applications and equipment requiring rotation of one part relative to another (either continuous rotation in a single direction, or reciprocating rotation in two directions). Such rotary swivels may be found, for example, in heavy lifting and cutting equipment used in the mining and forestry industries. There are also many other industries and applications in which rotary swivels are used, such as in the oil and gas industries. Lifting and/or cutting equipment typically have an upper part that may include a hydraulic lifting or cutting arm and an operator's cab, for example, which is required to swivel or rotate at a swivel connection in relation to a supporting base frame which typically supports a hydraulic fluid pump and sump. Often it is necessary to be able to pass a pressurized fluid such as hydraulic fluid, through the rotating swivel, so that equipment can be operated. For example, to be able to operate a lifting and/or cutting arm, pressurized hydraulic fluid must pass through the rotary swivel from a hydraulic pump to the arm. In order to operate such heavy equipment, the hydraulic swivels in these machines may be required to handle a wide range of hydraulic pressures, ranging from about 50 psi up to 5000 psi or more.

In some applications, a requirement for a period of continuous rotation or reciprocating rotation precludes the use of hydraulic hoses to facilitate the passage of processing of hydraulic fluid through the rotary swivel. Also, the wide range of hydraulic pressures required for certain applications may make the use of hydraulic hoses impractical. In such a case, as known in the art, rotary swivels with integrally formed passages (hereinafter referred to as “hydraulic rotary swivels”) many be used in place of hydraulic hoses. For example, U.S. Pat. No. 6,007,105 issued to Dietle et al. (“Dietle”) discloses a “swivel seal assembly” having “staged” rotary seal members that in part define sealed compartments or cavities in a space formed between an outer housing and an inner cylinder, the housing and cylinder being rotatable relative to each other. The sealed compartments and associated channels in Dietle are designed to support high-pressure fluid communication.

In some known designs, a rotary seal member is used together with an energizer member (e.g. a resiliently deformable o-ring) which is designed to deform under pressure, and urge the rotary seal member against an opposing sealing surface. These rotary seal members and energizer members together may define seals used to compartmentalize hydraulic fluids in “staged” compartments or cavities formed between the housing and the inner cylinder.

While known rotary seal member designs such as those described above are generally functional, due to the severe operating conditions found in some applications, the seal members and/or the associated energizer members may rapidly wear down and the seal may fail.

An improved rotary seal member and assembly design which may extend the operational life of a hydraulic rotary swivel by reducing the occurrence of such seal failures is therefore desirable.

### SUMMARY

A rotary seal member, assembly and associated methods for use in a hydraulic rotary swivel are disclosed. The hydraulic rotary swivel includes a first part and a second part rotatable relative to each other. The rotary seal member is positioned between the first part and the second part and can be adapted to be securely retained in a corresponding retaining groove which may be formed in either one of the first part and the second part. In a preferred embodiment, the rotary seal member had an elongate body forming a ring, and has at least one protuberance formed along its length which fits into a cooperating depression formed along the retaining groove. In use, the protuberance and corresponding depression are coupled and cooperate to substantially prevent the rotary seal member from rotating within the retaining groove.

In an embodiment, a corresponding energizer member may be used together with the rotary seal member, and in this case the coupling of the protuberance and corresponding depression will maintain the rotary seal member in a stationary position relative to the energizer member.

The inventors have recognized that a significant proportion of seal failures in hydraulic rotary swivels are caused by rotary seal members undesirably rotating within their corresponding retaining grooves. Such undesirable rotation may cause significant friction between the rotary seal member and a part or surface not designed to sustain such dynamic friction. For example, when an energizer member is used together with the rotary seal member, these members are designed to remain stationary relative to each other. If subjected to frictional forces for which it is not designed, the energizing member and seal may rapidly degrade and disintegrate in the retaining groove, causing seal failure, and possible blockage of channels and orifices connected to the affected compartments by the disintegrating energizing member.

Advantageously, by practicing the teachings of the present invention, the likelihood of a seal failure resulting from the above identified problem can be significantly reduced.

In a first aspect of the invention, there is provided a rotary seal member for forming a seal in a hydraulic rotary swivel, said hydraulic rotary swivel including a first part and a second part rotatable relative to each other in at least one direction and said first part and said second part each having a surface, said surface of said first part opposing the surface of said second part at an interface therebetween, said opposing surfaces of said first and second parts being separated by a gap, said rotary seal member comprising:
(a) an elongated annular body forming a closed ring and being positioned at said interface in said gap between said first part and said second part to provide a seal between said first part and said second part, said elongated body being adapted to be retained in a corresponding annular shaped retaining groove formed in said surface of one of said first part and said second part to engage at said interface said opposing surface of the other of said first part and said second part so as to provide said seal;
(b) at least one protuberance formed on said elongate body, said at least one protuberance being adapted to fit within a corresponding depression formed in a surface of said one of said first part and said second part,
wherein, during operation of said rotary swivel to rotate said first part and said second part relative to each other, the interaction of said at least one protuberance and said corresponding depression assists in substantially preventing rotation of said elongated body relative to said annular retaining groove in at least one direction.

Advantageously, by practicing the teachings of the present invention, the likelihood of a seal failure resulting from the above identified problem can be significantly reduced.

In an embodiment, said corresponding depression is formed along a surface of said retaining groove.

In another embodiment, said elongated body forming said ring further includes an energizer member receiving surface and a sealing surface.

In another embodiment, said elongate body of said rotary seal member has first and second sides, and at least one protuberance extends laterally from at least one of said first and second sides.

In another embodiment, said elongate body forming said ring further includes an energizer member receiving surface and a sealing surface.

In another embodiment, said energizer member receiving surface of said elongate body is adapted to receive an energizer member placed in said retaining groove.

In another embodiment, said sealing surface of said elongate body is adapted to slideably contact said opposing surface formed by the other of said first part and said second part.

In another embodiment, said at least one protuberance and said corresponding depression cooperate to retain said rotary seal member in said retaining groove in stationary contact with said energizer member.

In another embodiment, said energizer member is a resiliently deformable o-ring.

In another embodiment, said at least one protuberance extending laterally from at least one of said first and second sides is less than the thickness of said rotary seal member.

In another embodiment, said at least one protuberance is adjacent said sealing surface.

In another embodiment, said elongate body has a plurality of protuberances formed thereon, and said retaining groove has corresponding depressions.

In another embodiment, said plurality of protuberances are substantially evenly spaced on said elongate body.

In another embodiment, said one of said first part and said second is a cylinder member housed within and which encircles the other of said first part and second part, and said other part is an outer housing surrounding said inner cylinder.

In another embodiment, said one of said first part and said second is a first cylinder member having a generally flat annular end surface and having said annular groove formed therein, and wherein the other of said first part and said second part is a second cylinder member having a generally flat annular end surface, said first and second cylinders being in longitudinal alignment such that said annular end surfaces of said first and second cylinders form said opposing surfaces at said interface.

In a second aspect of the invention, there is provided a rotary seal assembly for a hydraulic rotary swivel, said hydraulic rotary swivel including a first part and a second part rotatable relative to each other in at least one direction and said first part and said second part each having a surface, said surface of said first part opposing the surface of said second part at an interface therebetween, said opposing surfaces of said first and second parts being separated by a gap, said rotary seal assembly comprising:
(a) an annular rotary seal member comprising an elongate body forming a closed ring and being positioned at said interface in between said first part and said second part to provide a seal, said elongate body having at least one protuberance formed thereon;
(b) an annular retaining groove formed in one of said first part and said second part, said retaining groove being adapted to receive said rotary seal member therein, said retaining groove being formed in one of said first part and said second part to engage an opposing surface formed by the other of said first part and said second part at said interface, said one of said first part and said second part having at least one depression corresponding to and cooperating with said at least one protuberance such that, during operation of said rotary swivel, the interaction of said at least one protuberance and said corresponding depression assists in substantially preventing rotation in at least one direction of said rotary seal member in said annular retaining groove.

In an embodiment, said first part is an inner cylinder and said second is an outer housing, said inner cylinder and said outer housing having a substantially cylindrical interface and a common central axis of rotation.

In another embodiment, said one of said first part and said second is a cylinder member housed within and which encircles the other of said first part and second part, and said other part is an outer housing surrounding said inner cylinder.

In another embodiment, said first part and said second part are rotatable relative to each other about longitudinal axes which are parallel to each other.

In another embodiment, said first part and said second part are rotatable about a common longitudinal axis.

In another embodiment, said first part and said second part are rotatable relative to each other about longitudinal axes which are parallel to each other.

In another embodiment, said first part and said second part have a common longitudinal axis of rotation.

In another embodiment, said outer housing is fixed to a frame and said inner cylinder rotates relative to said outer housing.

In another embodiment, one of said first part and said second is a first cylinder member having a generally flat annular end surface and having said annular groove formed therein, and wherein the other of said first part and said second part is a second cylinder member having a generally flat annular end surface, said first and second cylinders being in longitudinal alignment such that said annular end surfaces of said first and second cylinders form said opposing surfaces at said interface.

In a third aspect of the invention there is provided a hydraulic rotary swivel, said hydraulic rotary swivel including a first part and a second part rotatable relative to each other in at least one direction and said first part and said second part each having a surface, said surface of said first part opposing the surface of said second part at an interface therebetween, said opposing surfaces of said first and second parts being separated by a gap, said hydraulic rotary swivel including:
at least one rotary seal assembly, each rotary seal assembly comprising:
(a) an annular rotary seal member comprising an elongate body forming a closed ring and being positioned at said interface in between said first part and said second part to provide a seal, said elongate body having at least one protuberance formed thereon;
(b) an annular retaining groove formed in one of said first part and said second part, said retaining groove being adapted to receive said rotary seal member therein, said one of said first part and said second part having at least one depression corresponding to and cooperating with said at least one protuberance such that, during operation of said rotary swivel, the interaction of said at least one protuberance and said corresponding depression assists in preventing rotation of said rotary seal member in said annular retaining groove in at least one direction.

In an embodiment, said hydraulic rotary swivel further comprises first and second rotary seal assemblies and wherein said first and second rotary seal assemblies define a sealed compartment between said first part and said second part.

In another embodiment, said first part is an inner cylinder and said second is an outer housing, said inner cylinder and said outer housing having a substantially cylindrical interface and a common central axis of rotation.

In another embodiment, said one of said first part and said second is a cylinder member housed within and which encircles the other of said first part and second part, and said other part is an outer housing surrounding said inner cylinder.

In another embodiment, said one of said first part and said second is a first cylinder member having a generally flat annular end surface and having said annular groove formed therein, and wherein the other of said first part and said second part is a second cylinder member having a generally flat annular end surface, said first and second cylinders being in longitudinal alignment such that said annular end surfaces of said first and second cylinders form said opposing surfaces at said interface.

In a fourth aspect of the invention, there is provided a method of adapting a retaining groove in a hydraulic rotary swivel to receive a rotary seal member, said hydraulic rotary swivel including a first part and a second part rotatable relative to each other and having a common interface, said rotary seal member being positioned at said interface in between said first part and said second part to provide a seal, said retaining groove being formed in one of said first part and said second part and being adapted to receive said rotary seal member therein, said method comprising:
(i) identifying the size, shape and position of a protuberance provided on said rotary seal member;
(ii) for each said protuberance identified in (i), forming a corresponding depression along said retaining groove, each said depression corresponding in size, shape and position to said protuberance.

In an embodiment, two depressions are formed by a single machining operation, said depressions being formed on either side of said retaining groove and being adapted to receive corresponding protuberances provided on said rotary seal member.

In another embodiment, one depression is formed by a single machining operation on one side of said retaining groove, each said depression being adapted to receive a corresponding protuberance provided on said rotary seal member.

In a fifth aspect of the invention, there is provided a method of forming a rotary seal assembly for a hydraulic rotary swivel, said hydraulic rotary swivel including a first part and a second part rotatable relative to each other and having a common interface, said method comprising:
(i) forming a retaining groove in one of said first part and said second part at said interface, said retaining groove being adapted to receive a corresponding rotary seal member therein and to position said rotary seal member at said interface in between said first part and said second part to provide a seal;
(ii) forming in said retaining groove at least one depression corresponding to at least one protuberance provided on said rotary seal member;
(iii) fitting said corresponding rotary seal member in said retaining groove such that said at least one depression and said at least one protuberance are coupled,
such that, during operation of said rotary swivel, the interaction of said at least one protuberance and said corresponding depression assists in retaining said rotary seal member in a substantially stationary position relative to said retaining groove.

In an embodiment, the method further comprises:
(iv) placing an energizing member in said retaining groove beneath said rotary seal member, such that said retaining groove urges said rotary seal member against an opposing sealing surface formed by the other of said first part and said second part.

These foregoing and other aspects of the invention will be apparent from the following more particular descriptions of exemplary embodiments of the invention.

### BRIEF DESCRIPTION OF THE DRAWINGS

In the figures which illustrate various exemplary embodiments of the invention:

FIG. 1A shows a front view of an illustrative hydraulic rotary manifold in which exemplary embodiments of the invention may be found.

FIG. 1B is a top view of the hydraulic rotary manifold of FIG. 1A.

FIG. 1C is a cross-section of the hydraulic rotary manifold of FIG. 1B, showing a housing and a cylinder inside the housing.

FIG. 2 is a perspective view of a rotary seal member in accordance with an exemplary embodiment, together with a cooperating energizer member (e.g. a resiliently deformable o-ring) and a corresponding retaining groove formed in an inner surface of the housing of FIG. 1C.

FIG. 3 is a linear “top view” representation of the retaining groove of FIG. 2.

FIGS. 4A and 4B are first and second cross-sections, respectively, taken through the retaining groove of FIG. 3.

FIG. 5 is a linear “top view” representation of a rotary seal member in accordance with an exemplary embodiment.

FIGS. 6A and 6B are first and second cross-sections taken through the rotary seal member of FIG. 5, and shown together with a cross-section of the energizer member of FIG. 2.

FIG. 7 is a linear “top view” representation of the rotary seal member of FIG. 5 fitted into the retaining groove of FIG. 3.

FIGS. 8A and 8B are first and second cross-sections taken through FIG. 7, showing the seal and energizer member of FIGS. 6A and 6B in the groove of FIG. 3.

FIG. 9A is a detailed cross-section of a rotary seal member in accordance with an exemplary embodiment.

FIG. 9B is another view of the detailed-cross section of FIG. 9A showing the rotary seal member in use, and being acted on by various forces.

FIG. 10 is a rotary seal member in accordance with another exemplary embodiment, together with an energizing o-ring, and a corresponding groove formed in an outer surface of a cylinder.

FIG. 11A is an illustrative example of a method of forming the depressions of FIG. 3.

FIG. 11B is an illustrative example of another method of forming the depressions.

FIG. 12 is a rotary seal member and assembly in accordance with another exemplary embodiment.

### DETAILED DESCRIPTION OF EXEMPLARY EMBODIMENTS

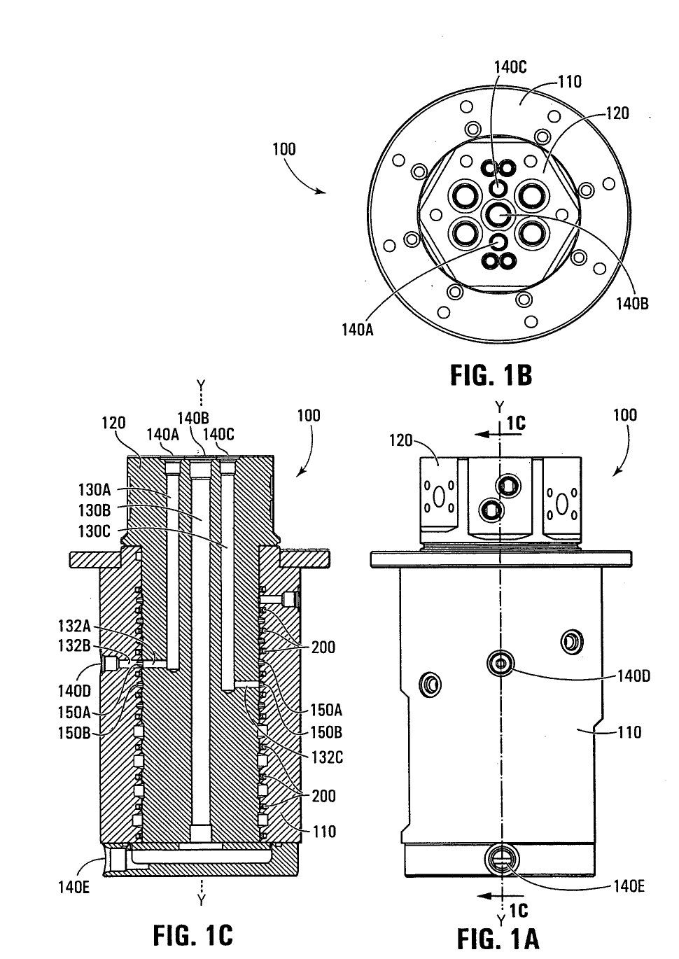

Referring to FIGS. 1A-1C, an illustrative hydraulic rotary swivel 100 is shown in which exemplary embodiments of the invention may be found. FIG. 1A is a “front view” of the hydraulic rotary swivel 100, FIG. 1B is a corresponding “top view”, and FIG. 1C is a cross-section taken through the hydraulic rotary swivel 100 of FIG. 1A at 1C-1C. Typically, the hydraulic rotary swivel 100 of FIGS. 1A-1C may be machined from a block of metal, such as steel or ductile iron. Various other metals may also be used. The hydraulic rotary swivel 100 of FIGS. 1A-1C is merely illustrative, and is not meant to be limiting in terms of the type of rotary equipment in which the invention can be used.

The hydraulic rotary swivel 100 of FIGS. 1A-1C may also be called a “hydraulic rotary manifold” or “hydraulic rotary union”. A “manifold” is a block having chambers or channels branching through it from/to a plurality of openings in the block. For the purposes of the present description, the terms “swivel”, “manifold”, and “union” may be used interchangeably and will all have the same meaning.

As shown in FIGS. 1A-1C, the hydraulic rotary swivel 100 includes a first part and a second part rotatable relative to each other and held in fixed longitudinal relation to each other. In this illustrative example, a “barrel” or outer housing 110, and a “spool” or inner cylinder 120 provided inside the outer housing 110 comprise the first and second parts which can swivel or rotate relative to each other about a common, central, longitudinal axis Y-Y (FIGS. 1A and 1C) in one or both directions. The rotational mount of each part can be continuous or intermittent in one direction, or alternate in direction. It will be appreciated, and in this specification and claims, it is to be understood, that being rotatable relative to each other means, either or both of the first and second parts might be capable of rotation relative to a reference frame. Typically, however, in a piece of commercial equipment, one part will usually be held stationary relative to a supporting frame and the other member will rotate relative to that one part and the supporting frame. In this invention, it does not matter which part(s) actually rotates relative to a frame of reference. In the preferred embodiments discussed herein, one or both of the first and second parts both rotate about a common, central, longitudinal axis. The rotation of the first and/or second parts is typically caused by a separate conventional drive device or mechanism (not shown), the nature of which will depend upon the particular application in which the rotary swivel is employed.

A plurality of channels 130a-130c and corresponding openings 140a-140e may be formed in the inner cylinder 120 and the outer housing 110 to provide fluid communication of a pressurized hydraulic fluid such as a pressurized hydraulic oil through a plurality of channels between and through the outer housing 110 and inner cylinder 120, even as the outer housing 110 and cylinder rotate relative to each other. (For the sake of brevity, only some of the channels and openings are labeled in FIGS. 1A-1C.) The hydraulic pressure of the hydraulic fluid throughout the channels in the rotary swivel can vary considerably (e.g. 50-5000+ psi), and can vary in such a manner even at the same location.

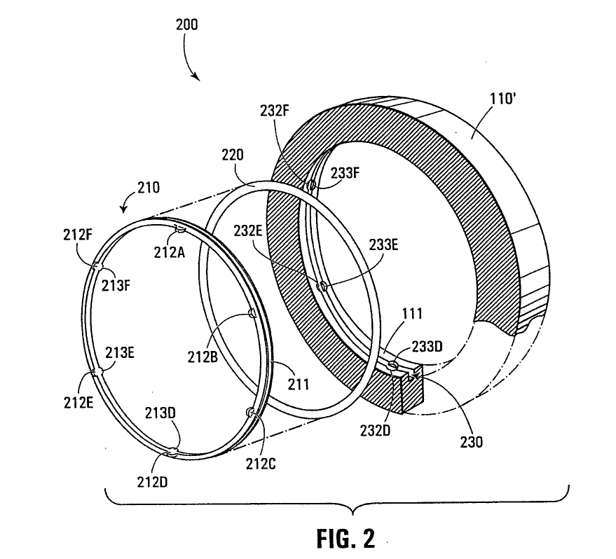

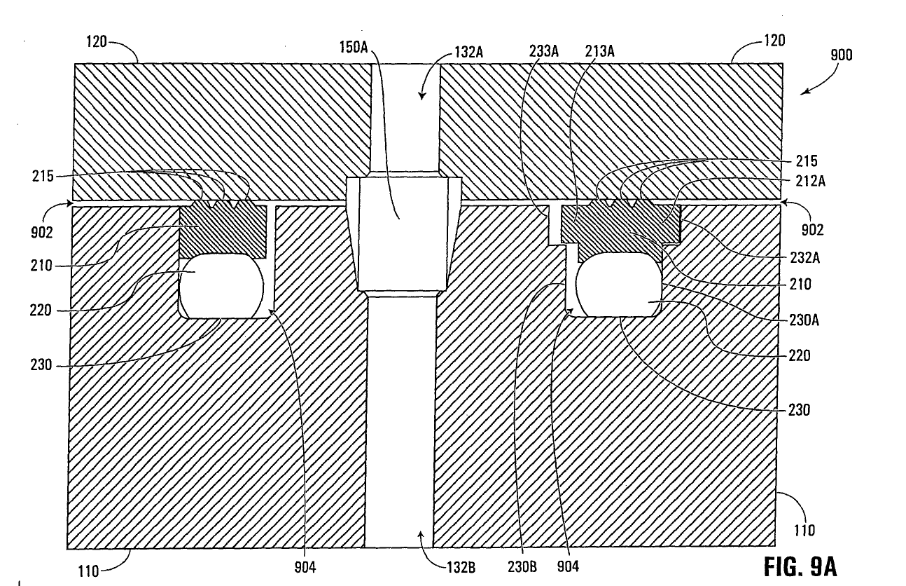

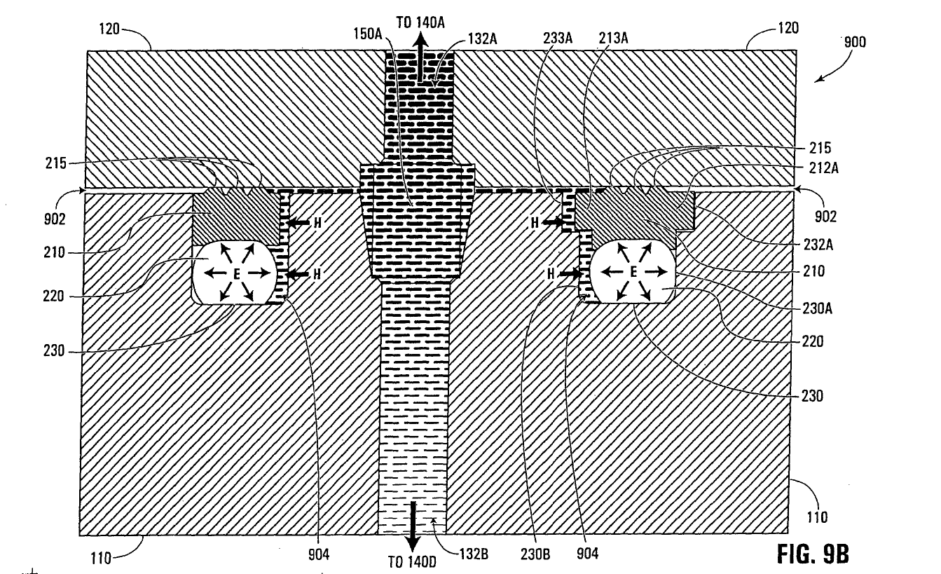

FIG. 1C shows a plurality of rotary seal assemblies 200 (as shown in detail in FIG. 2 below) located between the outer housing 110 and the inner cylinder 120. The rotary seal assemblies 200 may form annular “compartments” or “stages” in spaces formed between the outer housing 110 and the inner cylinder 120. For example, channel 130a leads to secondary channel 132a which is in fluid communication with one such compartment 150a. As shown, opening 140d is also in fluid communication with the compartment 150a via another secondary channel 132b. Furthermore, channel 130c leads to secondary channel 132c which is in fluid communication with a compartment 150b. As will be appreciated by those skilled in the art, various arrangements and configurations for such channels 130a-130c, 132a-132c, openings 140a-140e, and compartments 150a-150b are possible. Additional details on a possible configuration of the compartment 150a, the channels 132a, 132b, and adjacent rotary seal assemblies 200 are provided further below with reference to FIGS. 9A and 9B.

FIG. 2 shows a perspective view of a rotary seal assembly 200 in accordance with an exemplary embodiment. The rotary seal assembly 200 includes a suitably sized rotary seal member 210, a suitably sized and shaped energizer member 220, and a corresponding retaining groove 230 formed in a surface. For example, as shown, the retaining groove 230 may be formed in an inner surface 111 of the outer housing 110 of FIG. 1. (For illustration, only a small longitudinal section 10′ of the outer housing 110 is shown in a cut-out view in FIG. 2.) The seal member 210 is suitably sized so as to be able to be received in retaining groove 230 along with energizer member 220, and to function as a seal.

As known to those skilled in the art, the energizer member 220 is used to “energize” the seal member 210 so that a secure seal is obtained between the seal member 210 and an opposing sealing surface. For example, the energizer member 220 may be a resiliently deformable o-ring which can be suitably shaped and sized to be friction and/or compression fitted on the rotary seal member 210. The resiliently deformable o-ring may then provide a compression fit seal between the rotary seal member 210 and the corresponding retaining groove 230.

The o-ring may be made of a suitable rubber or polymer compound. The inventors have discovered that nitrile is a particularly effective material for the energizer member 220 or o-ring, as nitrile exhibits desirable properties including resilience, durability, and resistance to breakdown by hydraulic fluids and lubricants.

When subjected to hydraulic fluids as described hereafter (with reference to FIGS. 9A and 9B, below), in addition to applying resilient compression energizing forces on the seal member 210, the energizer member 210 may exert a further energizing force to further urge the rotary seal member 210 against an opposing sealing surface of inner cylinder 120. This is explained in more detail with reference to FIGS. 9A and 9B below.

The rotary seal member 210 may have an elongate body forming a ring, with an outer surface, an inner surface and two sides. The rotary seal member 210 may also have a slight recess 211 on its outer surface to receive the energizer member 220. The rotary seal member 210 may also have a sealing surface adapted to sealingly contact an opposing sealing surface on the inner cylinder 120, while permitting the sealing surface of said rotary seal member 210 to rotate relative thereto.

The rotary seal member 210 has at least one protuberance 212a-212f, 213a-213f (collectively 212, 213) formed thereon. (Protuberances 213a-213c are hidden from view in FIG. 2.) As shown, in an embodiment, the protuberances 212a-212f, 213a-213f may extend laterally from the sides of the rotary seal member 210.

While six sets of evenly spaced protuberances 212a-212f, 213a-213f are shown, in alternative embodiments, other than six sets, and other than even spacing between the protuberances may be used. Also, while the protuberances 212a-212f, 213a-213f are shown to be evenly sized, in alternative embodiments, other than evenly sized protuberances may also be used. As well, while the protuberances 212a-212f, 213a-213f are shown extending from both sides of the rotary seal member 210, it will be appreciated that, in an alternative embodiment, the protuberances need extend from only one side. Furthermore, while the protuberances 212a-212f, 213a-213f are shown as having a shape that is a part of a circle, it will be appreciated that in alternative embodiments, rectangular, triangular, or any other suitable shape (not shown) may also be used.

The rotary seal member 210 may be made of a suitable plastic material having adequate hardness and durability for a given application. For example, the rotary seal member 210 may be made of Teflon™ (registered trademark of E. I. du Pont de Nemours and Company), filled Teflon, or acetal.

As shown in FIG. 2, the retaining groove 230 may be provided with depressions 232a-232f, 233a-233f corresponding in size, position and spacing to each of the protuberances 212a-212f, 213a-213f. (Depressions 232a-232c, 233a-233c are hidden from view in FIG. 2.) If the protuberances 212a-212f, 213a-213f are evenly spaced and evenly sized, it will be appreciated that the depressions 232a-232f, 233a-233f may be adapted to accommodate any one of the protuberances 212a-212f, 213a-213f. However, as explained above, this need not be the case.

The retaining groove 230 and the depressions 232a-232f, 233a-233f may be machined or formed from the material used to form the hydraulic rotary swivel 100.

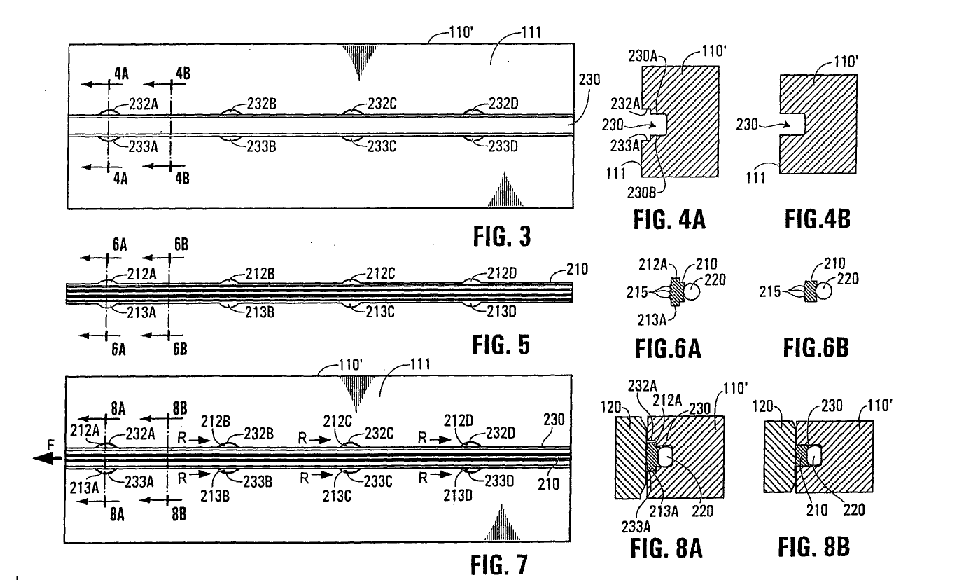

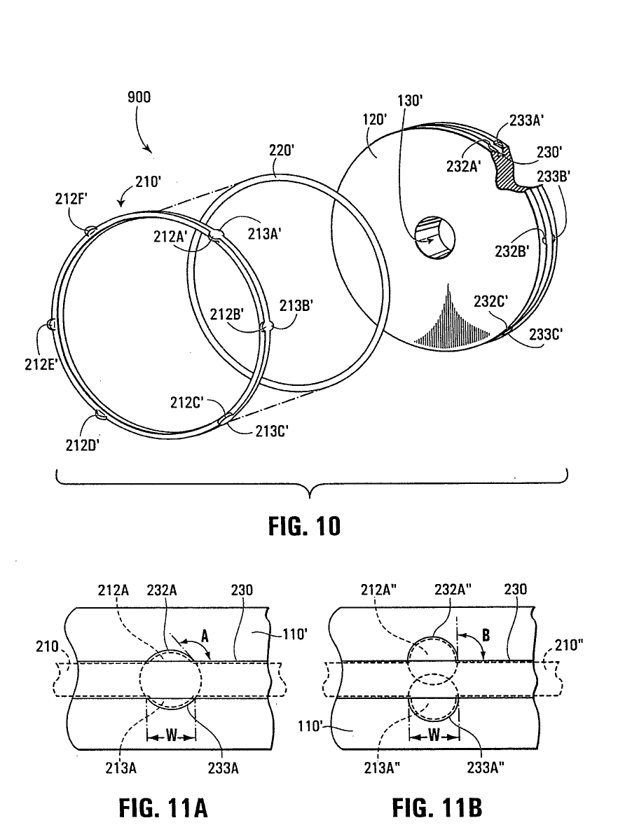

FIG. 3 shows a more detailed schematic linear representation of the retaining groove 230 of FIG. 2 in accordance with an exemplary embodiment. As described above, the retaining groove 230 may be formed, for example, on the inner surface 111 of the outer housing 110. (Alternatively, a retaining groove 230′ may also be formed on an outer surface 211 of the inner cylinder 210, as best shown in FIG. 10 below.) For the purposes of illustration, only some of the depressions (namely depressions 232a-232d, 233a-233d) are shown in FIG. 3.

FIGS. 4A and 4B are first and second cross-sections, respectively, taken through the retaining groove 230 of FIG. 3. In an embodiment, as shown in FIG. 4A, the depressions 232a and 233b are formed for only a part of the depth of the groove 230. FIG. 4B shows a cross-section taken through the groove 230 at a location having no depressions.

FIG. 5 is a linear representation of the rotary seal member 210 of FIG. 2 in accordance with an exemplary embodiment. For the purposes of illustration, only some of the protuberances (namely protuberances 212a-212d, 213a-213d) are shown in FIG. 3. As shown, the depressions 232a-232d, 233a-233d of FIG. 3 correspond closely in size, position and spacing to the protuberances 212a-212d, 213a-213d.

FIGS. 6A and 6B are first and second cross-section views, respectively, taken through the rotary seal member 210 of FIG. 5, and shown together with an energizer member 210. FIG. 6A is a cross-section view taken at protuberances 212a and 213a, and FIG. 6B is a cross-section view taken at a location having no protuberances. As shown in FIG. 6A, the protuberances 212a, 213a are suitably shaped and sized to fit in the depressions 232a, 233a shown in FIG. 4A.

Also, as shown in FIG. 6A, the protuberances 212a, 213a have a thickness less than the thickness of the rotary seal member 210. This is so that, if the rotary seal member 210 is urged by hydraulic pressure against one of the side walls 232a, 232b of the groove 232 (as explained with reference to FIG. 9B below), then the rotary seal member 210 will be able to form a continuous sealing surface against one of the walls 230a, 230b.

As shown in FIGS. 6A and 6B, the surface of the rotary seal member 210 may be provided with a plurality of raised seal contact points 215, which are explained in more detail with reference to FIG. 9B, below.

FIG. 7 is a linear representation of the rotary seal member 210 of FIG. 5 fitted into the corresponding retaining groove 230 of FIG. 3. As shown, all of the protuberances 212a-212d, 213a-213d and the corresponding depressions 232a-232d, 233a-233d are matched, so that the rotary seal member 210 is prevented from rotating in the groove 230.

It will be noted that in this embodiment, the rotation of seal member 210 is prevented in both rotational directions (i.e. it will be prevented no matter which direction the outer housing and/or inner housing are rotating). However, the protuberances and corresponding depressions may be configured so as to prevent rotation of the seal member in the groove in only one direction, if that is all that is required.

Also, it should be noted that a a precise matching or mating of protuberances and depressions may not be necessary to achieve the desired effect of preventing rotation of the seal member 210 in the retaining groove 230.

FIGS. 8A and 8B show a cross-section of the retaining groove 230, the energizer member 220, and the rotary seal member 210, as well as an opposing sealing surface (provided here, for example, by the outer surface of the inner cylinder 120). As will be appreciated, the rotary seal member 210 must protrude at least slightly out of the retaining groove 230. As the rotary seal member 210 is energized by the energizer member 220 (as described further hereafter), it is the rotary seal member 210 and not the inner surface 112 of the outer housing 110 which contacts the outer surface of the inner cylinder 120.

FIG. 9A is a detailed cross-section of a pair of rotary seal assemblies (such as those shown in cross-section in FIGS. 8A and 8B) forming a sealed compartment or cavity therebetween. More specifically, compartment 150A (FIG. 1C) connected by a pair of channels 132A, 132B (FIG. 1C) is sealed on either side by a rotary seal assembly, each including a rotary seal member 210, an energizer member 220, and a retaining groove 230. As shown, a gap 902 is formed between the outer housing 110 (FIG. 1C) and the inner cylinder 120 (FIG. 1C). In an embodiment, the rotary seal member 210 and energizer member 220 may be suitably shaped and sized to have some degree of lateral clearance, leaving a space 904 with one of the side walls of the retaining groove 230.

In FIG. 9A, the rotary seal assembly on the right has a cross-section through protuberances 212A, 213A and corresponding depressions 232A, 233A, as previously shown in FIG. 8A. The rotary seal assembly on the left has a cross-section as previously shown in FIG. 8B.

FIG. 9B shows the same view as in FIG. 9A but with the compartment 150A, channels 132A, 132B, gaps 902 (between the rotary seal assemblies), and gaps 904 filled with a hydraulic fluid. As shown, during operation of the hydraulic rotary swivel 100, the pressurized hydraulic fluid flowing thorough the passageways in the swivel between the outer housing 110 and the inner cylinder 120 exerts hydraulic pressure “H” on the rotary seal members 210 and the energizer members 220 to urge them against an opposite side wall of the retaining grooves 230.

In normal operation, the energizer members 220 are designed to urge the rotary seal members 210 up against opposing sealing surfaces (in this example, the outer surface of the inner cylinder 120). As shown, each of the energizer members 220 exerts an energizing force “E” on the seal member 210 as a result of various mechanical forces and hydraulic pressure acting on the energizer members 220. More specifically, as previously discussed, the energizing force “E” may include a resilient force component (i.e. the resilient force exerted by the energizer member 220 upon compression), as well as an additional force resulting from application of hydraulic pressure on the energizer member 220. As will be apparent from FIG. 9B, the hydraulic pressure “H” will have a tendency to deform the energizer members 220 such that the energizer members 220 further urge the seal members 210 against the opposing sealing surface provided by the outer surface of the inner cylinder 120.

As described earlier, raised seal contact areas 215 may be used to reduce the overall frictional forces between the rotary seal member 210 and an opposing sealing surface. As well, spaces between the raised seal contact areas 215 may retain hydraulic fluid that may reduce friction.

Over time, however, various factors may cause frictional forces between the rotary seal member 210 and an energizer member 220 to become less than is necessary to overcome the dynamic frictional forces created during relative rotation between the rotary seal member 210 and an opposing sealing surface in housing 120. Again, it will be appreciated that it is only important that there is relative rotational movement between the seal member 210 held on inner cylinder 110 and outer housing 120. With previous rotary seal assembly designs, this has often lead to the problem identified earlier, where a rotary seal member may undesirably rotate against a part (e.g. the energizer 220) not designed to sustain significant dynamic friction.

Advantageously, due to at least one protrusion 212A, 213A being provided on the rotary seal member 210, and a corresponding depression 232A, 233A being provided along the retaining groove 230, the rotary seal member 210 can be substantially prevented from rotating in the retaining groove in the same direction as frictional force “F”, due to counteracting resistance forces “R” provided by the interaction between the at least one protrusion 212A, 213A and the corresponding depression 232A, 233A (see FIG. 7). As will be appreciated, this may significantly extend the life of an energizer member 220 used with the rotary seal member 210, and consequently the seal formed by a rotary seal assembly may last longer. This may in turn extend the operational life of a hydraulic rotary swivel 100 using such a rotary seal assembly.

In an alternative embodiment, as shown in FIG. 10, a rotary seal member 210′ may be adapted to be placed in a corresponding groove 230′ formed in an outer surface 121 of the inner cylinder 120. In this embodiment, the rotary seal member 210′ may have suitable resilience characteristics allowing the rotary seal member 210′ to be stretched slightly to be fit into place in the corresponding groove 230′. Here, for illustration, a small section 120′ of the inner cylinder 120 is shown. As well, for illustration, a channel 130b (FIG. 1C) is shown passing through the inner cylinder 120.

In the embodiment shown in FIG. 10, a plurality of protuberances 212a′-212f′, 231a-213f′ (protuberances 213d′-213f′ are hidden in FIG. 10) extend laterally adjacent an outer edge of the rotary seal member 210′ (as compared to the inner edge of rotary seal member 210 as shown in FIG. 2). As shown, corresponding depressions 232a′-232f′, 233a′-233f′ (corresponding depressions 232d′-232f, 233d′-233f′ are hidden in FIG. 10) are provided along the retaining groove 230′. A corresponding energizer member 220′ (e.g. a resiliently deformable o-ring) may be suitably sized and shaped to be placed in the groove 230′ and to urge the rotary seal member 210′ against an opposing sealing surface (such as the inner surface of the outer housing 110). During the relative rotational movement of the inner cylinder 120 and outer housing 120, the seal is prevented from rotating relative to the outer housing 110 and its corresponding groove.

FIG. 11A is an illustrative example of a method of forming depressions 232a, 233a in the groove 230 of FIG. 3. In an embodiment, a cutting tool (not shown) of a suitable diameter may be used to machine both depressions 232a, 233a, having a width “W”, at the same time. Also, as shown, a tangential angle “A” is formed by the depression 232a. It will be understood that the depth of the depressions 232a, 233a may be controlled by the depth of penetration of the cutting tool.

FIG. 11B is an illustrative example of another method of forming alternative depressions 232a″, 233c″ in the groove 230 of FIG. 3. In this embodiment, a smaller cutting tool of a suitable diameter (not shown) may be used to form the depressions 232a″, 233c″, having a width “W”, in two operations. As shown, using this alternative method, a sharper tangential angle “B” may be formed by the depression 232a″. With correspondingly shaped protuberances 212a″, 213a″ formed on a rotary seal member 210″, it will be appreciated that the sharper angle B may provide a more secure catch to prevent the rotary seal member 210″ from rotating. This may be particularly significant if a gap is provided between the rotary seal member 210″ and the corresponding retaining groove 230 such that there is some “play” between the rotary seal member 210″ and the retaining groove 230.

While exemplary embodiments of the invention have been described, it will be apparent to those skilled in the art that various changes and modifications may be made. For example, while the rotary seal member 220, 220′, 220″ described above has been shown placed in a groove formed either on an outer surface of an inner cylinder 120, or on an inner surface of an outer housing 110, more generally, it will be appreciated that a rotary seal member may be provided at virtually any interface formed between a first part and a second part rotatable relative to each other and where a seal is required.

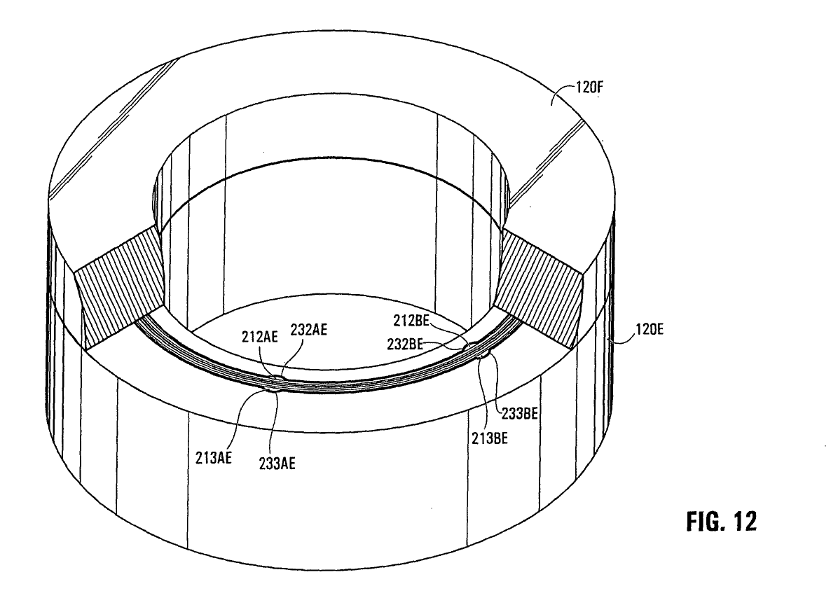

For example, as shown in FIG. 12, a modified rotary seal member 220E may be received in a retaining groove 230E formed into an end surface of a first cylinder 120E. A second cylinder 120F positioned above cylinder 120E provides an opposing sealing surface and may rotate relative to the first cylinder 120E. Based on the embodiments already described, with reference to FIG. 2-FIG. 11B, it will be readily apparent to those skilled in the art that various channels, inlets and outlets may be formed between and through the first and second cylinders 120E and 120F to provide various arrangements for sealing fluids, such as hydraulic fluids, while one cylinder rotates relative to the other.

As shown, a plurality of protuberances 212AE, 213AE, 212BE, 213BE provided on the rotary seal member 220E may be fitted into corresponding depressions 232AE, 233AE, 232BE, 233BE provided along the retaining groove 230E to prevent the rotary seal member 220E from rotating within the retaining groove 230E. Other protuberances and corresponding depressions are hidden from view in FIG. 12. Taking into account the different orientation, it will be appreciated that the identified seal failure problem and the solution to the problem as taught by the present invention are also applicable to the illustrative example shown in FIG. 12.

It will be appreciated that numerous other variations and embodiments are possible, the scope of the invention being limited only by the following claims.

1. A rotary seal member for forming a seal in a hydraulic rotary swivel, said hydraulic rotary swivel including a first part and a second part rotatable relative to each other in at least one direction and said first part and said second part each having a surface, said surface of said first part opposing the surface of said second part at an interface therebetween, said opposing surfaces of said first and second parts being separated by a gap, said rotary seal member comprising:
(a) an elongated annular body forming a closed ring and being positioned at said interface and extending into said gap between said first part and said second part to provide a seal between said first part and said second part, said elongated body being adapted to be retained in a corresponding annular shaped retaining groove formed in said surface of one of said first part and said second part to engage at said interface said opposing surface of the other of said first part and said second part so as to provide said seal;
(b) at least one protuberance formed on said elongate body, said at least one protuberance being adapted to fit within a corresponding depression formed in a surface of said one of said first part and said second part,
wherein, during operation of said rotary swivel to rotate said first part and said second part relative to each other, the interaction of said at least one protuberance and said corresponding depression assists in substantially preventing rotation of said elongated body relative to said annular retaining groove in at least one direction.

2. The rotary seal member of claim 1, wherein said corresponding depression is formed along a surface of said retaining groove.

3. The rotary seal member of claim 1, wherein said elongated body forming said ring further includes an energizer member receiving surface and a sealing surface.

4. The rotary seal member of claim 1, wherein said elongate body of said rotary seal member has first and second sides, and at least one protuberance extends laterally from at least one of said first and second sides.

5. The rotary seal member of claim 4, wherein said elongate body forming said ring further includes an energizer member receiving surface and a sealing surface.

6. The rotary seal member of claim 5, wherein said energizer member receiving surface of said elongate body is adapted to receive an energizer member placed in said retaining groove.

7. The rotary seal member of claim 6, wherein said sealing surface of said elongate body is adapted to slideably contact said opposing surface formed by the other of said first part and said second part.

8. The rotary seal member of claim 7, wherein said at least one protuberance and said corresponding depression cooperate to retain said rotary seal member in said retaining groove in stationary contact with said energizer member.

9. The rotary seal member of claim 8, wherein said energizer member is a resiliently deformable o-ring.

10. The rotary seal member of claim 5, wherein said at least one protuberance extending laterally from at least one of said first and second sides is less than the thickness of said rotary seal member.

11. The rotary seal member of claim 10, wherein said at least one protuberance is adjacent said sealing surface.

12. The rotary seal member of claim 1, wherein said elongate body has a plurality of protuberances formed thereon, and said retaining groove has corresponding depressions.

13. The rotary seal member of claim 12, wherein said plurality of protuberances are substantially evenly spaced on said elongate body.

14. The rotary seal member of claim 1 wherein one of said first part and said second is a cylinder member located within and which is encircled by the other of said first part and second part, and said other part is an outer housing surrounding said inner cylinder.

15. The rotary seal member of claim 1 wherein one of said first part and said second is a first cylinder member having a generally flat annular end surface and having said annular groove formed therein, and wherein the other of said first part and said second part is a second cylinder member having a generally flat annular end surface, said first and second cylinders being in longitudinal alignment such that said annular end surfaces of said first and second cylinders form said opposing surfaces at said interface.

16. The rotary seal member as claimed in claim 1 wherein said at least one protuberance and said corresponding depression are configured to prevent rotation of said elongated body in said at least one direction and in an opposite direction.

17. A rotary seal assembly for a hydraulic rotary swivel, said hydraulic rotary swivel including a first part and a second part rotatable relative to each other in at least one direction and said first part and said second part each having a surface, said surface of said first part opposing the surface of said second part at an interface therebetween, said opposing surfaces of said first and second parts being separated by a gap, said rotary seal assembly comprising:
(a) an annular rotary seal member comprising an elongate body forming a closed ring and being positioned at said interface in between said first part and said second part to provide a seal, said elongate body having at least one protuberance formed thereon;
(b) an annular retaining groove formed in one of said first part and said second part, said retaining groove being adapted to receive said rotary seal member therein, said retaining groove being formed in one of said first part and said second part to engage an opposing surface formed by the other of said first part and said second part at said interface, said one of said first part and said second part having at least one depression corresponding to and cooperating with said at least one protuberance such that, during operation of said rotary swivel, the interaction of said at least one protuberance and said corresponding depression assists in substantially preventing rotation in at least one direction of said rotary seal member in said annular retaining groove.

18. The rotary seal assembly of claim 17, wherein said elongate body of said rotary seal member has first and second sides, and at least one protuberance extends laterally from at least one of said first and second sides.

19. The rotary seal assembly of claim 17, further comprising an energizer member suitably sized and shaped to be placed in said retaining groove, and suitably sized and shaped to be received on an energizer member receiving surface on said rotary seal member.

20. The rotary seal assembly of claim 19, wherein said energizer member is suitably adapted to urge, in use, said rotary seal member against an opposing sealing surface formed by one of said outer surface of said inner cylinder and said inner surface of said outer housing.

21. The rotary seal assembly of claim 20, wherein said energizer member is made of nitrile.

22. The rotary seal assembly of claim 17, wherein said rotary seal member has a plurality of protuberances formed thereon, and said retaining groove has corresponding depressions formed therein.

23. The rotary seal assembly of claim 22, wherein said plurality of protuberances are substantially evenly spaced on said rotary seal member.

24. The rotary seal assembly of claim 17, wherein said first part is an inner cylinder and said second is an outer housing, said inner cylinder and said outer housing having a substantially cylindrical interface and a common central axis of rotation.

25. The rotary seal assembly of claim 17 wherein one of said first part and said second is a cylinder member located within and which is encircled by the other of said first part and second part, and said other part is an outer housing surrounding said inner cylinder.

26. The rotary seal assembly of claim 25 wherein said first part and said second part are rotatable relative to each other about longitudinal axes which are parallel to each other.

27. The rotary seal assembly of claim 26 wherein said first part and said second part are rotatable about a common longitudinal axis.

28. The rotary seal assembly of claim 17 wherein said first part and said second part are rotatable relative to each other about longitudinal axes which are parallel to each other.

29. The rotary seal assembly of claim 28 wherein said first part and said second part have a common longitudinal axis of rotation.

30. The rotary seal assembly of claim 29 wherein said outer housing is fixed to a frame and said inner cylinder rotates relative to said outer housing.

31. The rotary seal assembly as claimed in claim 17 wherein said at least one protuberance and said corresponding depression are configured to prevent rotation of said elongated body in said at least one direction and in an opposite direction.

32. The rotary seal assembly of claim 17 wherein one of said first part and said second is a first cylinder member having a generally flat annular end surface and having said annular groove formed therein, and wherein the other of said first part and said second part is a second cylinder member having a generally flat annular end surface, said first and second cylinders being in longitudinal alignment such that said annular end surfaces of said first and second cylinders form said opposing surfaces at said interface.

33. A hydraulic rotary swivel, said hydraulic rotary swivel including a first part and a second part rotatable relative to each other in at least one direction and said first part and said second part each having a surface, said surface of said first part opposing the surface of said second part at an interface therebetween, said opposing surfaces of said first and second parts being separated by a gap, said hydraulic rotary swivel including:
at least one rotary seal assembly, each rotary seal assembly comprising:
(a) an annular rotary seal member comprising an elongate body forming a closed ring and being positioned at said interface in between said first part and said second part to provide a seal, said elongate body having at least one protuberance formed thereon;
(b) an annular retaining groove formed in one of said first part and said second part, said retaining groove being adapted to receive said rotary seal member therein, said one of said first part and said second part having at least one depression corresponding to and cooperating with said at least one protuberance such that, during operation of said rotary swivel, the interaction of said at least one protuberance and said corresponding depression assists in preventing rotation of said rotary seal member said annular retaining groove in at least one direction.

34. The hydraulic rotary swivel of claim 33, further comprising first and second rotary seal assemblies and wherein said first and second rotary seal assemblies define a sealed compartment between said first part and said second part.

35. The hydraulic rotary swivel of claim 34, wherein said rotary seal member has an elongate body forming a ring, said elongate body having first and second sides, and said at least one protuberance extends laterally from at least one of said first and second sides.

36. The hydraulic rotary swivel of claim 35, wherein said rotary seal member further includes an energizer member receiving surface and a sealing surface.

37. The hydraulic rotary swivel of claim 36, wherein said energizer member receiving surface of said elongate body is adapted to receive an energizer member fitted into said retaining groove.

38. The hydraulic rotary swivel of claim 37, wherein said sealing surface of said elongate body is adapted to slideably contact an opposing sealing surface formed by the other of said first part and said second part.

39. The hydraulic rotary swivel of claim 33, wherein said elongate body has a plurality of protuberances formed thereon, and said retaining groove has corresponding depressions formed therein.

40. The hydraulic rotary swivel of claim 39, wherein said plurality of protuberances are substantially evenly spaced on said elongate body.

41. The hydraulic rotary swivel of claim 33, wherein said first part is an inner cylinder and said second is an outer housing, said inner cylinder and said outer housing having a substantially cylindrical interface and a common central axis of rotation.

42. The hydraulic rotary swivel of claim 33 wherein one of said first part and said second is a cylinder member housed within and which encircles the other of said first part and second part, and said other part is an outer housing surrounding said inner cylinder.

43. The hydraulic rotary swivel of claim 33 wherein one of said first part and said second is a first cylinder member having a generally flat annular end surface and having said annular groove formed therein, and wherein the other of said first part and said second part is a second cylinder member having a generally flat annular end surface, said first and second cylinders being in longitudinal alignment such that said annular end surfaces of said first and second cylinders form said opposing surfaces at said interface.

44. The hydraulic rotary swivel as claimed in claim 33 wherein said first part and said second part rotate relative to each other in said at least one direction and in an opposite direction wherein said at least one protuberance and said corresponding depression are configured to prevent rotation of said elongated body in said at least one direction and in an opposite direction.

45. A method of adapting a retaining groove in a hydraulic rotary swivel to receive a rotary seal member, said hydraulic rotary swivel including a first part and a second part rotatable relative to each other and having a common interface, said rotary seal member being positioned at said interface in between said first part and said second part to provide a seal, said retaining groove being formed in one of said first part and said second part and being adapted to receive said rotary seal member therein, said method comprising:
(i) identifying the size, shape and position of a protuberance provided on said rotary seal member;
(ii) for each said protuberance identified in (i), forming a corresponding depression along said retaining groove, each said depression corresponding in size, shape and position to said protuberance.

46. The method of claim 45, wherein two depressions are formed by a single machining operation, said depressions being formed on either side of said retaining groove and being adapted to receive corresponding protuberances provided on said rotary seal member.

47. The method of claim 46, wherein one depression is formed by a single machining operation on one side of said retaining groove, each said depression being adapted to receive a corresponding protuberance provided on said rotary seal member.

48. A method of forming a rotary seal assembly for a hydraulic rotary swivel, said hydraulic rotary swivel including a first part and a second part rotatable relative to each other and having a common interface, said method comprising:
(i) forming a retaining groove in one of said first part and said second part at said interface, said retaining groove being adapted to receive a corresponding rotary seal member therein and to position said rotary seal member at said interface in between said first part and said second part to provide a seal;
(ii) forming in said retaining groove at least one depression corresponding to at least one protuberance provided on said rotary seal member;
(iii) fitting said corresponding rotary seal member in said retaining groove such that said at least one depression and said at least one protuberance are coupled,
such that, during operation of said rotary swivel, the interaction of said at least one protuberance and said corresponding depression assists in retaining said rotary seal member in a substantially stationary position relative to said retaining groove.

49. The method of claim 48, further comprising:
(iv) placing an energizing member in said retaining groove beneath said rotary seal member, such that said retaining groove urges said rotary seal member against an opposing sealing surface formed by the other of said first part and said second part.
